(19) United States
(12) Patent Application Publication
(10) Pub. No.: US 2004/0121831 A1
(43) Pub. Date: Jun. 24, 2004

(54) Two round 3-card poker game and method of play

(76) Inventor: Thomas F. Perkins, Douglasville, GA (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/676,030

(22) Filed: Oct. 2, 2003

Related U.S. Application Data
(60) Provisional application No. 60/415,245, filed on Oct. 2, 2002.

(51) Int. Cl. G06F 17/00; G06F 19/00

(52) U.S. Cl. 463/13

(57) ABSTRACT

A three card game and method of playing includes two rounds. The game is playable using one or more standard decks of 52 cards or representations thereof. After payment of an ante/first play bet by each player, two cards are dealt face up to each player and to the dealer. Each player then either “folds,” losing the ante/first play bet and ending the game for that player, or places a second play bet to enter the second round. A third card is then dealt to each remaining player and to the dealer, and the cards are revealed. The dealer's cards are compared to each player's cards, with the high hand winning. If the player's hand wins, the house pays a return according to a pay table and based on the combined ante/first play bet and second play bet. If the dealer's hand wins, the player forfeits both bets.

This application claims priority from U.S. Provisional Patent Application Serial No. 60/415,245 of Thomas F. Perkins, filed Oct. 2, 2002, titled TWO ROUND 3-CARD POKER GAME AND METHOD OF PLAY. The entirety of that provisional application is incorporated herein by reference.

### BACKGROUND OF THE INVENTION

1. Field of the Invention

This invention relates to a game, and in particular to a two-round casino-style game played with at least one standard deck of cards, the game including a first round in which players see their first two cards, and a second round played with the first two cards and a third card, in accordance with the rules of poker and use of a pay table.

2. Background

It is known in the art to provide single round three card games, such as games for play on gaming tables at casinos. These known three card games include games such as “Three Card Poker.” Typical three card games, however, besides having only one round, include other features that discourage play or decrease players' incentive to play. For example, these games may prohibit players from winning if the dealer's hand is disqualified—the dealer's hand may have to have a rank of one jack or higher or one ace or higher, for example, in order for the players to have the opportunity to obtain a return on their bets. Failure of the dealer to qualify with such hands results in all of the players returning their cards, with no opportunity to win with the cards the players were dealt. Thus, a player making a large bet based on a good hand, could have the possibility of winning removed solely on the basis of the dealer's hand, and completely outside the player's expectation of winning given the hand the player has been dealt.

Another problem with some prior art three card games is that they include potential automatic winning for all players simply by comparing the players' hands to pay tables. This approach removes the variability and strategy inherent in, for example, comparing hands between the player and dealer, as occurs, for example, with Blackjack. In addition, this approach can be costly to the house or otherwise reduce the likelihood of house winnings, thereby reducing the attractiveness of the game to casinos.

Yet another problem with known three card games is that they typically consist of a single round, such that the play becomes repetitious for players, which can result in loss of interest on the part of players. In addition, because these games typically only include a single round, players have less incentive to play because no other variable game features, such as a different or additional round, occur to provide players with the opportunity to obtain winnings or to offset losses. There is a need for additional rounds to increase the likelihood or incentive for players to play even when losing at the three card game.

Accordingly, there is a need for a three card game that includes more than one round and additional variation and opportunity for players to win than single round poker-like three card games. There is a further need for three card games with rounds that provide for house incentive to offer the game. In particular, there is a need for a game that includes features that provide for variability and strategy with regard to players' opportunities to win, such as by comparing player's hands to a dealer's hand in order to receive the opportunity to win. There is also a need for a game that includes additional features for simple, winning hands for players to provide additional incentive for players to play in more variable, poker-like three card games.

### SUMMARY OF THE INVENTION

It is an advantage of the present invention to meet these needs, and others, by providing a three card game having two rounds to provide increased incentive for play of players and variability and sufficient likelihood of winning for the house.

It is a further advantage of the present invention to provide a simple first round card game in which each player receives two cards and bets on the likelihood of receiving a third card that might beat the dealer's hand and possibly match a set play table. It is yet a further advantage to provide for the option for each player to place additional bets at odds following receipt of a second card.

It is another advantage of the present invention to provide a second round in which three cards, including a third dealt card, along with the two cards initially dealt to each player in the first round, are compared to a dealer hand. It is yet a further advantage of the present invention to provide a payout in the second round only to player's hands that beat the dealer's hand. It is yet a further advantage to provide a payout in the second round to players based on comparison to a payout table. It is yet a further advantage of the present invention to include no qualifying requirement for the dealer's hand, which increases player incentive to play.

One aspect of the invention relates to a method for at least one player and a dealer to play a card game with a deck of cards. The method includes receiving a first selection from each of the at least one player, the selection indicating whether to participate in a first round of the card game, and dealing two cards from the deck of cards to each of the at least one player participating in the first round. The method further includes, following dealing two cards, receiving a second selection from each of the at least one player participating in the first round, the second selection indicating whether to participate in a second round of the card game. The method also includes dealing a third card from the deck of cards to each of the at least one player participating in the second round, dealing three cards from the deck of cards to the dealer, and identifying each of the at least one player winning the game. Identifying each of the at least one player winning the game includes determining whether the hand of each of the at least one player beats the hand of the dealer.

In an additional aspect of the invention, a method for at least one player to play a card game with representations of cards includes a receiving a first selection from each of the at least one player, the selection indicating whether to participate in a first round of the card game, and assigning two representations of cards to each of the at least one player participating in the first round. The method also includes, following assigning two representations of cards, receiving a second selection from each of the at least one player participating in the first round, the second selection indicating whether to participate in a second round of the card game, and assigning a third representation of a card to each of the at least one player participating in the second round. The method also includes designating three representations of cards as a dealer hand and identifying each of the at least one player winning the game. Identifying each of the at least one player winning the game includes determining whether the hand of each of the at least one player beats the dealer hand.

In yet a further aspect of the invention, a system for at least one player to play a card game with representations of cards includes at least one input device for the at least one player to input data for play of the card game, a processor coupled to the at least one input device for receiving input data from the at least one input device, and at least one display device coupled to the processor for displaying display information. The processor receives a first selection from each of the at least one player, the selection indicating whether to participate in a first round of the card game, and the processor assigns two representations of cards to each of the at least one player participating in the first round. Following assigning two representations of cards, the processor receives a second selection from each of the at least one player participating in the first round, the second selection indicating whether to participate in a second round of the card game. The processor assigns a third representation of a card to each of the at least one player participating in the second round, and the processor designates three representations of cards as a dealer hand. The processor identifies each of the at least one player winning the game. Identifying each of the at least one player winning the game includes determining whether the hand of each of the at least one player beats the dealer hand. The processor outputs information to the at least one display device.

In still a further aspect of the invention, a device for at least one player to play a card game with representations of cards includes an input device for the at least one player to input data for play of the card game, a payment input for the at least one player to input payment, a processor coupled to the input device for receiving the input data from the input device, and a display device coupled to the processor for displaying display information. The processor receives a first selection from each of the at least one player, the selection indicating whether to participate in a first round of the card game, and the payment input receives payment from each of the at least one player. The processor assigns two representations of cards to each of the at least one player participating in the first round, and, following assigning two representations of cards, the processor receives a second selection from each of the at least one player participating in the first round, the second selection indicating whether to participate in a second round of the card game. The processor assigns a third representation of a card to each of the at least one player participating in the second round, and the processor designates three representations of cards as a dealer hand. The processor identifies each of the at least one player winning the game. Identifying each of the at least one player winning the game includes determining whether the hand of each of the at least one player beats the dealer hand. The processor outputs information to the at least one display device.

In still a further aspect of the invention, a gaming table for at least one player and a dealer to play a card game with a deck of cards includes a table surface, a dealer location indicated on the table surface, and at least one player location indicated on the table surface. Each of the at least one player location includes an indicated ante/first play bet location and an indicated second play bet location. A first selection is received from each of the at least one player, the selection indicating whether to participate in a first round of the card game and two cards are dealt from the deck of cards to each of the at least one player participating in the first round. Following dealing two cards, a second selection is received from each of the at least one player participating in the first round, the second selection indicating whether to participate in a second round of the card game, and a third card is dealt from the deck of cards to each of the at least one player participating in the second round. Three cards are dealt from the deck of cards to the dealer and each of the at least one player winning the game is identified. Identifying each of the at least one player winning the game includes determining whether the hand of each of the at least one player beats the hand of the dealer.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 is an overhead view of the players, dealer, and gaming table for play of the game in accordance with one embodiment of the present invention;

FIG. 2 presents a gaming table layout for a gaming table in accordance with an embodiment of the present invention;

FIG. 3 depicts the components for electronic play if the game in accordance with one embodiment of the present invention;

FIG. 4 presents components for electronic play of the game using a network in accordance with an embodiment of the present invention; and

FIG. 5A-5C show a flow diagram of an example method of play in accordance with an embodiment of the present invention.

### DETAILED DESCRIPTION

In one embodiment, the present invention comprises a casino style three card game and method of playing that includes a first and optional second round for each player. The first round is referred to as an “ante/first play round,” and the second round is a three card poker-style game that includes use of a pay table.

In accordance with an embodiment of the present invention, play is conducted using one or more standard sets of 52 playing cards having values of Ace, 2, 3, 4, 5, 6, 7, 8, 9, 10, Jack, Queen, and King. The game may be optionally played with the Ace as the high or low card, or as optionally selectable as high or low by each player. Each participating player is seated at, for example, a playing table, as described further below, on the players' side of the table. The dealer is located on the dealer's side of the table, opposite the players. In one embodiment, the table is curved, having a convex side and an opening for the dealer, so that the dealer is easily able to deal to each player from the dealer opening in the table, and up to seven players are easily and comfortably accommodated on the convex side of the table.

The game may also be played with representations of any of the features described. For example, the game is playable in an electronic or partially electronic manner using a terminal, such as a personal computer, microcomputer, minicomputer, mainframe computer, or other device having a processor and display, such as an electronic hand-held game device, personal digital assistant, or cellular telephone, for which representative images of cards are displayable on a screen via a GUI. The game is also playable in conjunction with performance of selected functions on a network, such as the Internet or an intranet.

In the first round of the game, referred to as the “ante/first play round,” and also interchangeably referred to as the dealing round, each participating player is first dealt two cards down and in proximity to each other.

Before any cards are dealt to begin play of the game, each player decides whether to participate in the game by paying an ante/first play bet. In an embodiment played in conjunction with use of a gaming table, each player places the ante/first play bet in an ante/first play betting spot location for that player. The minimum and maximum bets for the ante/first play bet are determinable by the rules of the house, or, for example, by agreement among the players and the house or dealer.

After each player has determined whether or not to play and all antes have been placed, the dealer cuts the cards or alternatively shuffles and cuts the cards if the game is being played with a single deck of cards. The game is also playeble with multiple decks of cards using, for example, a card shoe, in which multiple decks are held and cards are dealt one at a time by removal from the shoe.

Typically, particularly if the game is played with a single deck, the dealer begins by placing the top card to one side as a security measure. Cards are then dealt one at a time face down to each player in turn, such that each player has one card face down. The dealer then deals one card to the dealer face down.

The process is then repeated so that each player has two cards face down and the dealer has two cards face down. In one embodiment, each player then elects whether to “fold,” and thereby not play in the second round, forfeiting the ante/first play bet, or to place a “second play” bet for participating in the second round. The minimum and maximum bets for “first play” and “second play” are determined by the rules of the house, or, for example, by agreement among the players and the house or dealer.

Next, the dealer deals a third card to each player, and the dealer and each player turn their cards face up. In the second round of the game, each player plays individually against the dealer, and each player can win, regardless of how many players remain. In an embodiment of the present invention, the second part of the game is played with the aforementioned previously dealt cards, in accordance with standard poker rules on high hand, in which each player's hand is compared to the dealer's hand in accordance with, for example, conventional casino poker rules and/or conventional rules of poker, as, for example, described in John Scarne, “Scarne's Encyclopedia of Card Games” (1995), which is hereby incorporated by reference. If the dealer's hand is higher than the player's hand, the player loses and, for example, the player's “ante/first play” and “second play” bet are both lost to the house. If the player's hand is higher than the dealer's hand, the player wins, and, for example, the player receives a variable bet return, which is determined using a pay table, based on the combined total of the player's “ante/first play” and “second play” bets wagered.

In an embodiment of the present invention, the dealer's hand includes no “qualifying” feature, such as a minimum hand or required cards (e.g., there is no requirement that the dealer have a Jack or better or Ace or better in order to play against the players). This lack of qualifying hand for the dealer is important, for example, for such purposes as the players' incentive to play is increased because potentially winning hands, as well as corresponding potentially winning bets, cannot be disqualified simply by lack of a hand on the dealer's part.

An embodiment of the present invention includes payout by a pay table to players having winning hands in the second round of the game. With the use of a pay table, a variable ratio payback is paid to each player depending on the player's hand. For example, in one embodiment, the pay table includes varying returns for winning players' hands for three of a kind, a straight, a flush, a straight flush, and a royal flush, consisting of a Queen, King, and Ace of the same suit. These returns may include, for example, one and a half to tone, two to one, or three to one or greater paybacks, depending on the hand. In an embodiment of the present invention, all other winning hands, for example, would be subject to a one to one return. In one embodiment, no return is paid if the player does not have at least a pair, and any bet is carried over to the next round (i.e., is a “push”). In an embodiment of the present invention, the returns in the pay table are determined using a mathematical formula to assure a predetermined likelihood of house returns.

No return, however, is paid to players having losing hands versus the dealer, regardless of the pay table payout indicated. Only winning hands versus the dealer are paid. Providing payment only upon a hand beating the dealer's hand provides an advantage over the prior art by increasing player incentive to play through use of strategy, while also increasing variability on house winnings over games having preset winning hands without the dealer and player comparison feature.

The game table used in conjunction with an embodiment of the present invention can be a standard blackjack or poker sized casino table, in which a dealer occupies one side of the table and players occupy the other. In one embodiment, the table includes a bar located on the dealer's side of the table. The table can also include the name of the game, “2 Play Poker.”

From the players' side, below the name (toward the players), are player positions for up to seven player spots. At each player's position are two betting spots or areas, one of which is marked “ante/first play” and the other marked “bet/second play.” At these betting spots, players place chips for betting as play of the game proceeds. In an embodiment of the present invention, the “ante/first play” spot is used to indicated selection to play in the game, and the “second play” spot is used for participation and betting with respect to the second round of the game. Because the “ante/first play” and “second play” spots are used as play proceeds, in order to reduce the likelihood of confusion or cheating by players, the “ante/first play” and “second play” spots are located adjacent to each other and toward the player on the table.

References will now be made in detail to embodiments of the present invention, examples of which are illustrated in the accompanying drawings.

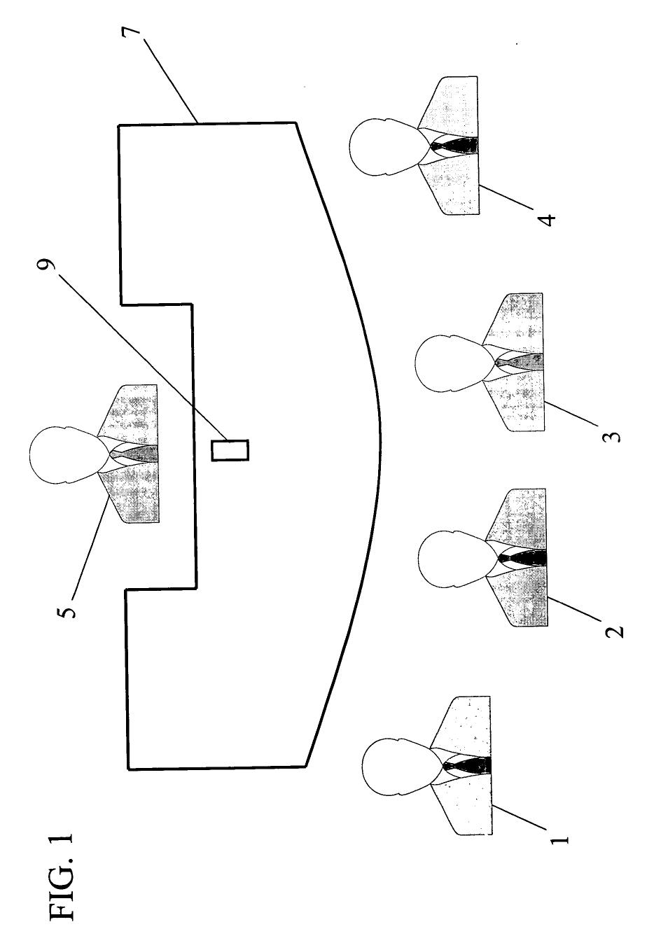

FIG. 1 is an overhead view of the players, dealer, and gaming table for play of the game in accordance with one embodiment of the present invention. FIG. 1 shows an embodiment of the game as played with one to seven players 1, 2, 3, 4 and a dealer 5 at a gaming table 7 using one or more decks of cards located at a card location 9.

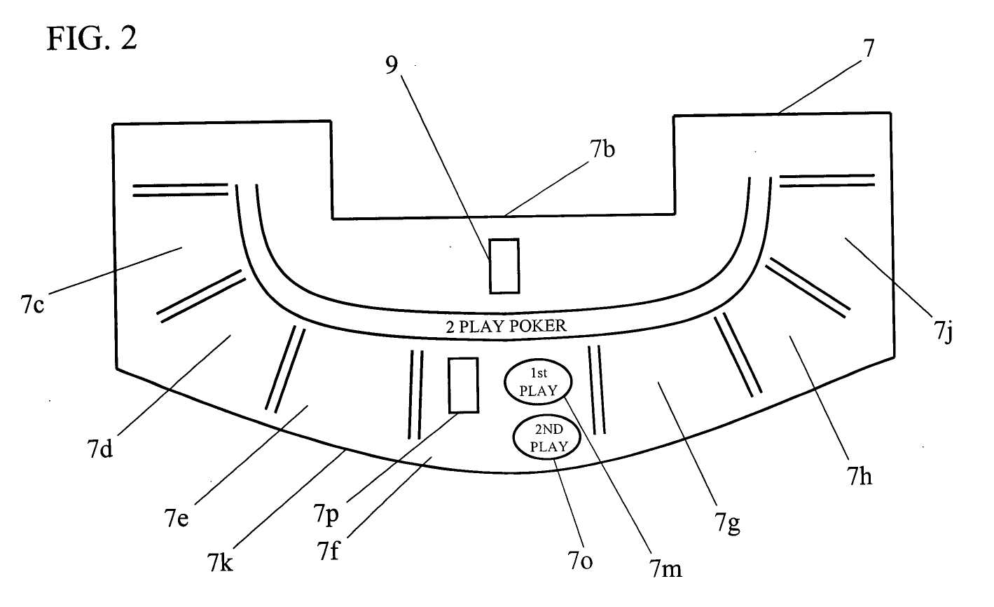

FIG. 2 presents a gaming table layout for a gaming table in accordance with an embodiment of the present invention. As shown in FIG. 2, the table 7 includes a deck placement area 9 on the dealer side of the table 7b and seven player areas 7c, 7d, 7e, 7f, 7g, 7h, 7j on the players' side of the table 7k. Each player area 7c, 7d, 7e, 7f, 7g, 7h, 7j includes two marked areas, an ante/first play spot 7m, for placement of a first wager, and a second play spot 7o, for placement of a second play wager.

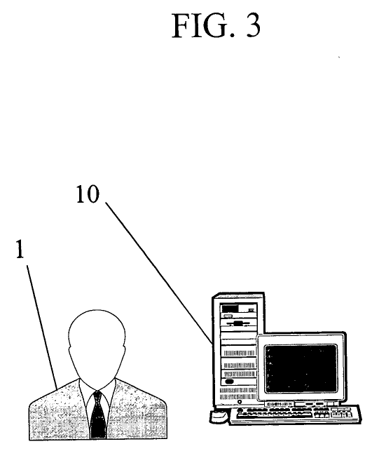

FIG. 3 depicts the components for electronic play of the game in accordance with one embodiment of the present invention. As shown in FIG. 3, in this embodiment, the player 1 plays at a terminal 10, such as a personal computer, a minicomputer, a microcomputer, a mainframe computer, or other device having a display, processor, and GUI, including a hand-held electronic game, personal digital assistant, cellular telephone, or slot machine, using software or other processed operations on the terminal 10.

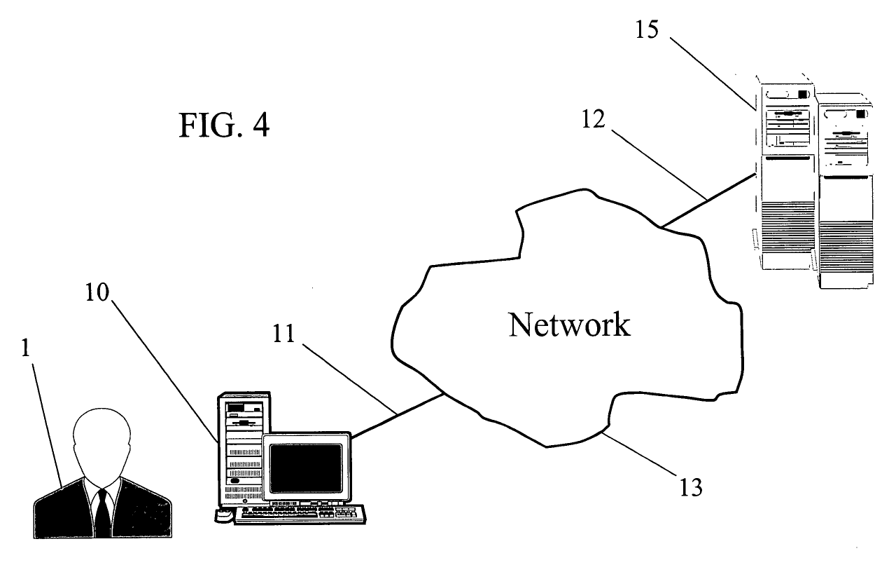

FIG. 4 presents components for electronic play of the game using a network, such as the Internet or an intranet, in accordance with another embodiment of the present invention. As shown in FIG. 4, a player 1 plays at a terminal 10, such as a personal computer, a minicomputer, a microcomputer, a mainframe computer, or other device having a display and processor. The terminal 10 is connected 11, 12 via, for example, wire, wireless, or fiberoptic coupling to a network 13, such as the Internet or an intranet, to a server 15, such as a personal computer, a minicomputer, a microcomputer, a mainframe computer, or other device having a processor. Software or other processing operations for use in play using these components can be located, for example, on the terminal 10, on the server 15, or both.

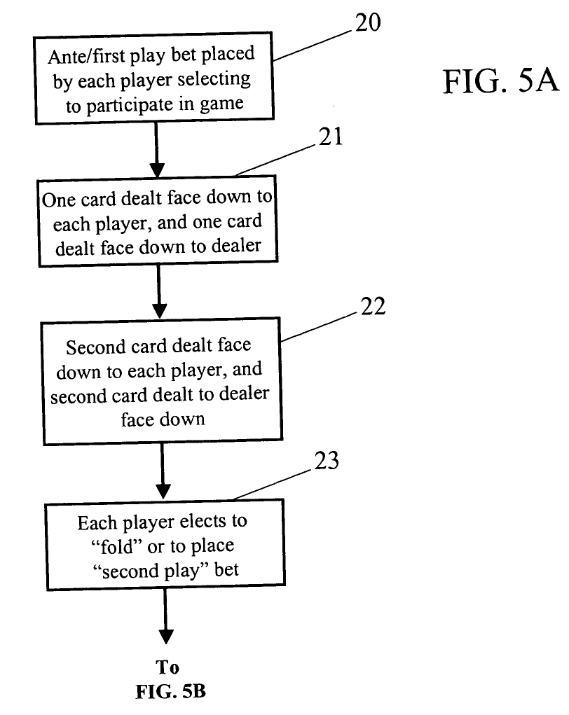

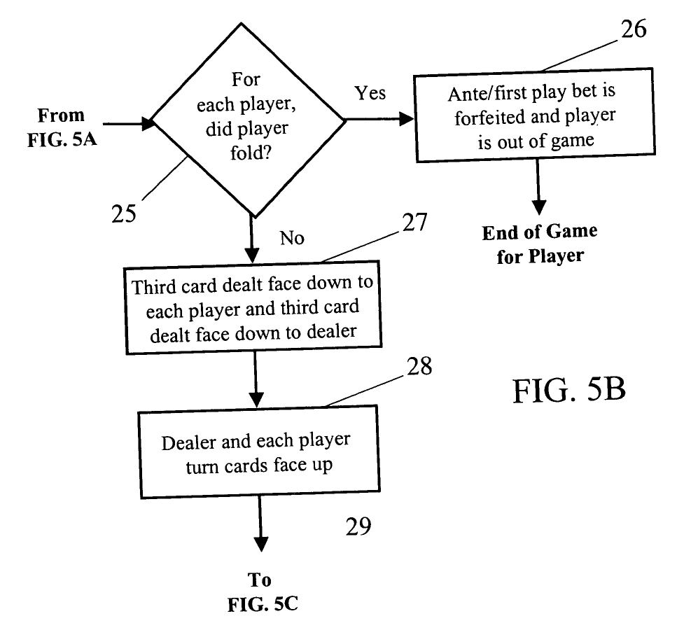

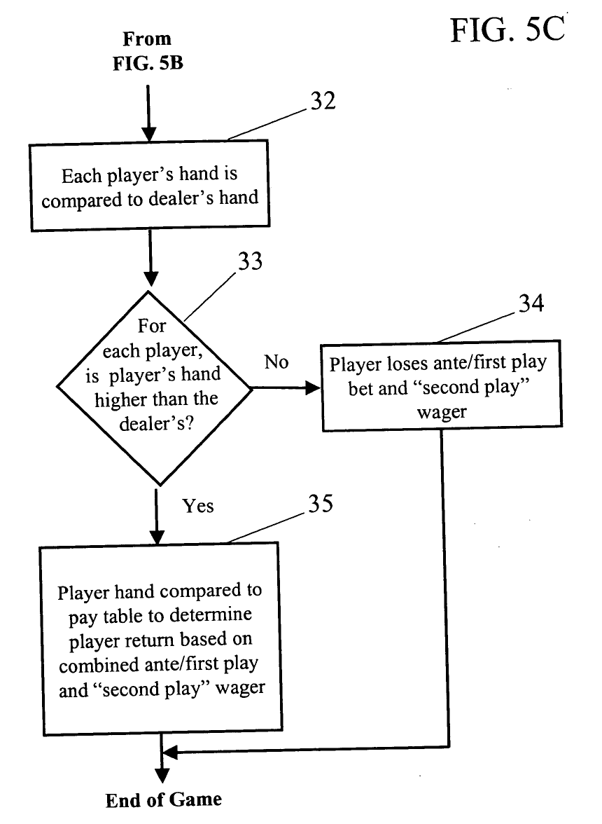

FIGS. 5A-5C show a flow diagram of an example method of play in accordance with an embodiment of the present invention. As shown in FIG. 5A, play of the game begins with an ante/first play bet placed by each player selecting to participate in the game 20. The ante/first play bet can be placed, for example, by the player positioning a wager in the ante/first play bet area for that player on a gaming table or, for example, by selecting an option on a terminal. A first card is then dealt face down to each player, and one card is dealt face down to the dealer 21. A second card is then dealt face down to each player, and a second card is dealt face down to the dealer 22. Each player then elects whether to “fold” (i.e., discontinue participation in the current game) or to place a second play bet for participation in the second round of the game 23.

As shown in FIG. 5B, a determination is then made as to whether each player folded 25. For each player electing to fold, the ante/first play bet is forfeited to, for example, the house 26, and play of the game ends for that player. The third card is dealt face down to each remaining player, and a third card is dealt face down to the dealer 27. The dealer then turns the dealer cards face up, and each of the players turns their cards face up 28.

Play of the second round then begins. As shown in FIG 5C, play of the second round begins by comparing each player's hand individually to the dealer's hand 32. For each player, a determination is made as to whether the player's hand is higher than the dealer's hand 33. For example, determination of the higher hand is conductible according to the value of hands determined in accordance with the rules of poker. If the dealers' hand is higher than the player's hand, the player loses the second round and loses the ante/first play bet and the second play bet wagered 34. If the player's hand is higher than the dealer's hand, the player wins, and the player's hand is compared to a pay table to determine the player return based on the combined ante/first play bet and second play bet wagered 35. For example, if the player has three of a kind, a straight, a flush, or a straight flush, the player's return may be variably greater than one to one, depending on the hand, while if the player does not have one of these hands, the player return may be one to one. The return is made, for example, by payment from the house.

Example embodiments of the present invention have now been described. It will be appreciated that these examples are merely illustrative of the invention. Many variations and modifications will be apparent to those skilled in the art. The scope of the invention is therefore intended to be limited only by the following claims.

What is claimed is:

1. A method for at least one player and a dealer to play a card game with a deck of cards, the game having a first round and a second round, the method comprising:
receiving a first selection from each of the at least one player, the selection indicating whether to participate in a first round of the card game;
dealing two cards from the deck of cards to each of the at least one player participating in the first round;
following dealing two cards, receiving a second selection from each of the at least one player participating in the first round, the second selection indicating whether to participate in a second round of the card game;
dealing a third card from the deck of cards to each of the at least one player participating in the second round;
dealing three cards from the deck of cards to the dealer; and
identifying each of the at least one player winning the game, wherein identifying each of the at least one player winning the game comprises determining whether the hand of each of the at least one player beats the hand of the dealer.

2. The method of claim 1, wherein the deck of cards is a standard deck of cards.

3. The method of claim 1, wherein the card game is played with multiple decks of cards.

4. The method of claim 1, wherein receiving the first selection comprises:
receiving a first ante/play bet.

5. The method of claim 1, wherein receiving the second selection comprises:
receiving a second play bet.

6. The method of claim 1, wherein dealing three cards from the deck of cards to the dealer comprises:
dealing two cards from the deck of cards to the dealer before receiving a second selection from each of the at least one player; and
dealing one card from the deck of cards to the dealer after receiving a second selection from each of the at least one player.

7. The method of claim 1, further comprising:
taking an ante/first play bet from each of the at least one player selecting not to participate in the second round.

8. The method of claim 1, further comprising:
taking an ante/first play bet and a second play bet from each of the at least one player not winning the game.

9. The method of claim 1, wherein determining whether the hand of each of the at least one player beats the hand of the dealer comprises:
evaluating the hand of each of the at least one player in accordance with the rules of poker;
evaluating the hand of the dealer in accordance with the rules of poker; and
determining that the hand of each of the at least one player beats the hand of the dealer if the hand of the at least one player is the high hand in comparison to the hand of the dealer.

10. The method of claim 1, further comprising:
paying a payout to each of the at least one player winning the game.

11. The method of claim 10, wherein the amount of the payout is calculated according to a pay table.

12. The method of claim 10, wherein the amount of the payout is based on the sum of the ante/first play bet and the second play bet.

13. A method for at least one player to play a card game with representations of cards, each representation of a card corresponding to a card in a standard deck of cards, the method comprising:
receiving a first selection from each of the at least one player, the selection indicating whether to participate in a first round of the card game;
assigning two representations of cards to each of the at least one player participating in the first round;
following assigning two representations of cards, receiving a second selection from each of the at least one player participating in the first round, the second selection indicating whether to participate in a second round of the card game;
assigning a third representation of a card to each of the at least one player participating in the second round;
designating three representations of cards as a dealer hand; and
identifying each of the at least one player winning the game, wherein identifying each of the at least one player winning the game comprises determining whether the hand of each of the at least one player beats the dealer hand.

14. A system for at least one player to play a card game with representations of cards, each representation of a card corresponding to a card in a standard deck of cards, the system comprising:
at least one input device for the at least one player to input data for play of the card game;
a processor coupled to the at least one input device for receiving input data from the at least one input device; and
at least one display device coupled to the processor for displaying display information;
wherein the processor receives a first selection from each of the at least one player, the selection indicating whether to participate in a first round of the card game;
wherein the processor assigns two representations of cards to each of the at least one player participating in the first round;
wherein, following assigning two representations of cards, the processor receives a second selection from each of the at least one player participating in the first round, the second selection indicating whether to participate in a second round of the card game;
wherein the processor assigns a third representation of a card to each of the at least one player participating in the second round;
wherein the processor designates three representations of cards as a dealer hand;
wherein the processor identifies each of the at least one player winning the game, identifying each of the at least one player winning the game comprising determining whether the hand of each of the at least one player beats the dealer hand; and
wherein the processor outputs information to the at least one display device.

15. The system of claim 14, further comprising a terminal.

16. The system of claim 14, further comprising at least one terminal on a network.

17. The system of claim 16, further comprising a server on the network.

18. The system of claim 17, wherein the at least one terminal and the server are coupled via a coupling.

19. The system of claim 18, wherein the coupling comprises one from the group consisting of a wired connection, a wireless connection, and a fiberoptic connection.

20. The system of claim 15, wherein the terminal comprises one selected from a group consisting of a personal computer, a minicomputer, a microcomputer, a mainframe computer, a telephone device, a hand-held gaming device, and a personal digital assistant.

21. The system of claim 17, wherein the server comprises one selected from a group consisting of a personal computer, a minicomputer, a microcomputer, and a mainframe computer.

22. The system of claim 16, wherein the network is the Internet.

23. The system of claim 16, wherein the network is an intranet.

24. A device for at least one player to play a card game with representations of cards, each representation of a card corresponding to a card in a standard deck of cards, the device comprising:
an input device for the at least one player to input data for play of the card game;
a payment input for the at least one player to input payment;
a processor coupled to the input device for receiving the input data from the input device; and
a display device coupled to the processor for displaying display information;
wherein the processor receives a first selection from each of the at least one player, the selection indicating whether to participate in a first round of the card game;
wherein the payment input receives payment from each of the at least one player;
wherein the processor assigns two representations of cards to each of the at least one player participating in the first round;
wherein, following assigning two representations of cards, the processor receives a second selection from each of the at least one player participating in the first round, the second selection indicating whether to participate in a second round of the card game;
wherein the processor assigns a third representation of a card to each of the at least one player participating in the second round;
wherein the processor designates three representations of cards as a dealer hand;
wherein the processor identifies each of the at least one player winning the game, identifying each of the at least one player winning the game comprising determining whether the hand of each of the at least one player beats the dealer hand; and
wherein the processor outputs information to the at least one display device.

25. The device of claim 24, wherein the device comprises a slot machine.

26. A gaming table for at least one player and a dealer to play a card game with a deck of cards, the gaming table comprising:
a table surface;
a dealer location indicated on the table surface; and
at least one player location indicated on the table surface, each of the at least one player location comprising
an indicated ante/first play bet location, and
an indicated second play bet location;
wherein a first selection is received from each of the at least one player, the selection indicating whether to participate in a first round of the card game;
wherein two cards are dealt from the deck of cards to each of the at least one player participating in the first round;
wherein, following dealing two cards, a second selection is received from each of the at least one player participating in the first round, the second selection indicating whether to participate in a second round of the card game;
wherein a third card is dealt from the deck of cards to each of the at least one player participating in the second round;
wherein three cards are dealt from the deck of cards to the dealer; and
wherein each of the at least one player winning the game is identified, identifying each of the at least one player winning the game comprising determining whether the hand of each of the at least one player beats the hand of the dealer.
